(19) United States
(12) Patent Application Publication
(10) Pub. No.: US 2008/0233356 A1
(43) Pub. Date: Sep. 25, 2008

(54) Method for the Application of a Structured Coating Upon a Smooth Surface

(75) Inventors: Stefan Loher, Montlingen (CH); Wendelin J. Stark, Winterthur (CH)

Correspondence Address: MARSHALL, GERSTEIN & BORUN LLP, 233 S. WACKER DRIVE, SUITE 6300, SEARS TOWER, CHICAGO, IL, 60606, US

(73) Assignees: PERLEN CONVERTING AG, PERLEN (CH); ETH ZURICH, ETH TRANSFER, ZURICH (CH)

(21) Appl. No.: 12/066,589

(22) PCT Filed: Sep. 12, 2005
(86) PCT No.: PCT/CH2005/000540

§ 371 Date: May 19, 2008

(51) Int. Cl. B05D 5/08; B05D 3/00; B32B 3/00; C08L 83/04

(52) U.S. Cl. 428/172; 427/385.5; 524/588

(57) ABSTRACT

A roll coating method for preparing a coated substrate with structured surface of the coating is described. Said method comprises application of a polymer based coating fluid to a substrate surface by means of a coating fluid application roll and then curing the applied coating, wherein the polymer based coating fluid is a fluid showing Bingham or Herschel-Bulkley flow behavior with a yield stress τ₀>10 dyn cm⁻², in particular a fluid having low viscosity at high shear rate, fast viscosity enhancement in the absence of shear stress and a high yield stress. Applications of such produced surfaces are release films, e.g. for pressure sensitive adhesives, controlled release adhesives and self-cleaning surfaces and friction coefficient reducing surfaces.

### TECHNICAL FIELD

The present invention concerns a production method for easily applying a structured surface upon a substrate, in particular a surface resulting in reduced release force or controlled release of adhesives and/or enhanced repellent properties, entailing a self-cleaning effect of the surface, and/or reduced friction of fluids flowing over the structured surface.

### BACKGROUND ART

For decades researchers have been improving existing or inventing new coatings which exhibit low adhesion properties. The application of low or controlled adhesion surfaces, so called release coatings, is pre-domindtely round in the use together with pressure sensitive adhesives, or tape, where the goal is to minimize and control the forces needed to apply in the peeling process [1]. Low adhesion to a substrate is also desired where surfaces have to be prevented of fouling. For instance reducing the adhesion of biological systems including proteins, tissue, microbes, algae and invertebrates to substratum is of great interest in the protection of surfaces exposed to biologically active media. The field of application ranges from tissue engineering [19] to marine biofouling on ships [2].

In general there are different ways to influence the characteristics of the substrate to subsequent adhesion events:

(1) Physico-chemical properties of the neat coating material. The most prominent candidates to date are without doubt silicone or fluorocarbon release coatings. Particularly thanks to the low surface free energy of silicone elastomers and fluoropolymers [3,4] these materials have evolved to the preferred choice when desiring low adhesion properties. Polydimethylsiloxane (PDMS), on the market since 1943, is still preferably used for release coating applications by reason of its relatively low cost (compared to fluoropolymers) and the easy processing. However there is an interest to reduce the release forces by applying materials with very low surface energies (<20 EN m⁻¹). Fluoropolymer, being such a promising candidate, unfortunately adds cost to the production and is in case of non-siloxane materials (e.g. PTFE) difficult to process. Nonetheless researchers are investigating on new silicone release coatings modified with fluorine (e.g. polymethylnonafluorohexylsiloxane PMNFHS) to achieve very low surface energy [4,5] while keeping the easy processing of siloxanes. Up today the application of such fluorine modified silicone release coatings is restricted to the use of low swelling coatings in presence of organic solvents dad for silicone based adhesives in particular for PDMS-based pressure sensitive adhesives [4]. In the field of pressure sensitive adhesion (PSA), PDMS is the key player and detailed studies of the release properties of silicone, were carried out by Gordon and co-workers [1, 6, 7]. Their studies concentrate preferably on controlled release, which means increasing the release force of a system while at the same time controlling it. A way to achieve said properties is to add so called high release additives (HRA), such as methyl silicate, which function as tackifiers and increase the bonding to the adhesive. A major drawback of the HAs is that they only show large impact in middle to low peel rates (0.005-0.17 m s⁻¹).

(2) Physical features such as roughness Structuring a surface entails a reduction of exposed top surface area which can be advantageous for the reduction of pressure sensitive adhesion. Depending on the adhesion system and the structure dimensions the adhesive system can only adhere to a limited surface area. Furthermore patterning can imply a self-cleaning effect, often referred to as the lotus-effect, if the pattern has a micron sized dimension [20]. In addition the fact of reduced friction coefficient for parallel flow over structured surfaces, as seen in nature by shark skin, has promoted the investigation on trying to mimic and understand the phenomena of reduced near wall drag forces [8-10]. Studies on continuous 2-D ribs revealed a drag reduction of approximately 9% attributed to a reduction of turbulent wall shear stress[9]. The optimal dimensionless lateral rib spacing s+ has to lie in a certain range

$${s}_{opt}^{+} = \frac{{s}_{opt} {u}_{τ}}{v} \approx 10 - 30$$

where sₒₚₜ is the optimal rip spacing, uᵣ is the shear velocity and ν the kinematic viscosity. For industrial and technically important flows in water an optimal rip spacing of several hundred micrometers can be calculated. The optimal rib height hₒₚₜ according to experimental investigations by Bechert was observed around

hₒₚₜ0.5·sₒₚₜ

The high demand for structured surfaces has brought up many different preparation methods. A series of processes for polymer-structuring are presented by Eldad 2000 [21]. The structure dimensions accessible for these methods range from <1 μm to several 100 μm. In the case of direct printing lithography the resulting pattern exhibits a high degree of accuracy and process latitude but it involves a multistep process and can not be produced continuously. Laser direct writing does not need any pre-structured tools, such as masks, but the scanning speed reaches a limit around 5 cm s⁻¹. Processes more suited for series production (continuous production and fast line speed) are casting, molding, hot embossing, and soft embossing. Unfortunately all these methods require complex processing tools which themselves carry the negatively structured pattern. Among the four, casting (DE10144579) and soft embossing (for paper embossing see EP 1 208 965, for PUR embossing see JP 2003 211 612; EP 1 123 799 A1) are the most promising production routes. Both methods require either a UV-transparent substrate or a UV-transparent tool for processing.

In conclusion both methods for lowering adhesion, although used in numerous applications, suffer from inherent disadvantages: Generally the materials with low surface free energy (e.g. siloxanes and fluoropolymers) are expensive and in the case of fluorocarbons difficult to apply on a given substrate. Surface structuring is often limited to non-continuous processes or requires complex processing tool which implicates costly cleaning steps and susceptibility to failure.

Extensive work has been done in the field of roll coating [11, 12, 13] because of its tremendous industrial relevance. These studies investigated the fluid dynamic behavior in the gap between two rolls and prediction of the forming fluid film on each roll was done. Moreover numerous publications have dealt with the question of undesired instability [11, 14-18] occurring in a fluid film split resulting in a wavy film-split meniscus. Therefore the film emanating from the split may exhibit a ribbed structure for specific process parameters. The instability in the meniscus is assumed to be a result of 2 small perturbation that grows with time [14]. A great body of work has focused on the coating and rib-forming of Newtonian fluids [22-27] despite its minor relevance in industrial application. Most fluids used in coating industry exhibit non-Newtonian behavior (e.g. polymer precursors). The effect of elasticity in so called Boger fluids (viscoelastic behavior) has attracted much interest in recent years. Several researchers have found that the condition for instability appear to depend on the parameter

ε^{1/2}·Wi

Where Wi is the Weissenberg number, representing the ratio of elastic to viscous forces and ε is a geometric parameter defining the dimensionless curvature in the flow. The Weissenberg number Wi=λ·\dot{γ} is given as the relaxation time (λ) times the shear rate (\dot{γ}). However most stability analysis are based on Newtonian fluids and go back to the work by Saffman and Taylor [28]. They related the onset of ribbing to a dimensionless capillary number

$$Ca = \frac{μ U}{σ}$$

(μ is the fluid viscosity, U the mean flow velocity and σ the surface tension of the applied fluid) and found a critical condition for air-to-fluid displacement (observed in most coating applications) in a Hele-Shaw cell with parallel walls as

$${Ca}_{crit} = \frac{( ρ - {ρ}_{air} ) {gb}^{2}}{12 σ}$$

where ρ is the fluid density, Pair is the air density, g is the gravity constant, and b is the gap thickness. From this consideration the onset of ripping in general is favored if the roll velocity or the viscosity of the fluid increases. If the constraining walls of the Hele-Shaw cell are not parallel the diverging or converging walls have an influence on the stability of the flow. Based on a one-dimensional stability analysis in the absence of gravitational effects and for constant mean flow velocity the critical condition can be expressed as

$${Ca}_{crit} = \frac{1}{3} tan ( \frac{α}{2} )$$

where α is the divergence angle (FIG. 1b). Including both gravitational stabilization and stabilization due to gap divergence leads to a modified Saffman-Taylor theory [17] for critical condition

$${Ca}_{crit} = \frac{1}{3} tan ( \frac{α}{2} ) + \frac{( ρ - {ρ}_{air} ) {gh}^{2} cos ( β )}{12 σ}$$

where α is also the divergence angle (FIG. 1b), ρ is the density of the applied fluid, ρₐᵢᵣ is the air density, g is the gravity constant, σ is the surface tension of the applied fluid, h is the local gap thickness at the meniscus (FIG. 1b), and β is the angular location of the meniscus (while β=0 in horizontal position).

Flow instability of yield-stress fluids can result in branched fingering of the fluid as observed in many experiments [29, 30]. These studies deal with the instability occurring in Hele-Shaw cells where a high viscous fluid is pushed by a low viscous fluid (air) and focus predominantly on the width of the fingers. To our best knowledge no studies have dealt with the Saffman-Taylor instability of yield-stress fluids in roll coating flow.

### DISCLOSURE OF THE INVENTION

Hence, it is a general object of the invention to provide a method and materials to perform said method that allow the easy formation of a structured, adhesion reducing surface on a smooth substrate.

Now, in order to implement these and still further objects of the invention, which will become more readily apparent as the description proceeds, the roll coating method for preparing a coated substrate with structured surface of the coating is manifested by the features that it comprises application of a polymer based coating fluid to a substrate surface by means of a coating fluid application roll and then curing the applied coating, wherein the polymer based coating fluid is a fluid showing Bingham or Herschel-Bulkley flow behavior with a yield stress τ₀>10 dyn cm⁻².

In a preferred embodiment, the capillary number of the gap between the coating fluid application roll and the substrate surface to be coated is above the critical capillary number if calculated according to the formula

$${Ca}_{crit} = \frac{1}{3} tan ( \frac{α}{2} ) + \frac{( ρ - {ρ}_{air} ) {gh}^{2} cos ( β )}{12 σ}$$

where α is the divergence angle (FIG. 1b), ρ is the density of the applied fluid, ρₐᵢᵣ is the air density, g is the gravity constant, σ is the surface tension of the applied fluid, h is the local gap thickness at the meniscus (FIG. 1b), and β is the angular location of the meniscus (while β=0 in horizontal position).

The fluid preferably is a Herschel-Bulkley fluid with low viscosity at high shear rate, fast viscosity enhancement in the absence of shear stress and a high yield stress.

While all studies on coating methods found in the state of the art aimed for elimination of rib forming, it has now surprisingly be found that—if some specific provisions are made—this fluid instability can be used to produce a defined patterning of the surface, said patterning e.g. resulting in an adhesion reducing effect.

The inventive method is performed using a continuous roll coating process, in particular a continuous three roll coating process.

It has now been found that direct roll coating can be used to superimpose a shear-thinning resin with Bingham behavior (in particular so called Herschel-Bulkley fluids) resulting in a textured, fine to micron sized surface after curing.

The Herschel-Bulkley model generally expresses the shear stress as a function of shear rate:

τ=τ₀+K·\dot{γ}ⁿ 0≦τ0

where τ is the shear stress, τ₀ is the yield stress, K is the power law coefficient, \dot{γ} is the shear rate, and n is the power law exponent. n=1 corresponds to Newtonian behavior and n<1 is observed in shear-thinning fluids, e.g. Herschel-Bulkley fluids. In the scope of the present invention τ₀>0 is important, in particular τ₀>10. Such yield stress resulting in high relaxation times is known for Bingham fluids as well as for Herschel-Bulkley fluids. A preferred yield stress is >50 dyn cm⁻², more preferred >100 dyn cm⁻², most preferred >250 dyn cm⁻².

The benefit of the proposed method is the capability of low cost series production. Advantages of the structured surface comprise

(1) the reduction of the accessible surface area to which adhesives, such as pressure sensitive adhesives, can adhere, resulting in reduced release force or controlled release,

(2) enhancement of repellent properties, entailing a self-cleaning effect of the surface and

(3) reducing the friction of fluids flowing over the structured surface.

The method of the present invention is applicable for all fluids having the needed rheological properties, namely a yield stress as defined above. Preferred are fluids having a relatively low viscosity at high shear rates which makes the resin well applicable by roll coating and immediate viscosity enhancement in the absence of shear rate.

In order to achieve the Bingham or the preferred Herschel-Bulkley behavior, usually a rheology modifier has to be used. In the case of Herschel-Bulkley behavior, said rheology modifier is preferably an agglomerated, nanoparticulate material, in particular an inorganic material (e.g. silica). Suitable agglomerated nanoparticulate materials are in particular materials with a specific surface area >50 m²/g, most preferred >200 m²/g. Such material can be purchased, e.g. under the name Aerosil® 200 from Degussa, or prepared according to WO 2004/005184.

The agglomerated particulate material in general has a mass fractal dimension of Dₘₐₛₛ<2.5, preferably <2.3, more preferably between 1.8 and 2.3.

The fine tuning of the rheological behavior is done by adding an appropriate amount of an appropriate solvent. The amount as well as the solvent used are dependent from the polymer or the polymer composition. For polymers selected from the group consisting of siloxanes, acrylates, olefins and non polar polymers e.g. solvents selected from lower alcohols, such as C₂-C₄ alcohols, in particular 2-propanol, as well as aliphatic or aromatic hydrocarbons or mixtures of such solvents are suitable.

Preferred solvents are those with a boiling point of <120° C., preferably <90° C. Much preferred, however, are solvent free systems.

Preferred parameters of the coating fluids are e.g. a relatively low viscosity of <100 Poise=<10 Pa s at high shear rates of >50 rad sec⁻¹ and high yield stress of >50 dyn cm⁻². The yield stress is a very important parameter, since the structure has to be pre-served after formation until fixation of the pattern by curing. Preferred parameters are as defined above, namely >50 dyn cm⁻², preferably >100 dyn cm⁻², much preferred >250 dyn cm-2.

The patterning arises due to the rheological behaviour of the specific resin on the one hand, but also due to the coating conditions. The coating conditions have to be chosen above the critical capillary number (calculated using the formula shown above) where instability of the film split occurs. Dependent on the coating fluid and the process parameters different patterns can be achieved, e.g. predominantly branched or predominantly single-tooth ribbing of high regularity.

In this connection, predominantly of one or the other structure type means that for branched structure one rib will split into two ribs which themselves have a point of splitting into another two ribs and so forth. The length of the ribs after a splitting point in this case exceeds the rib spacing by at least a factor of 10. In predominately single tooth ribbing one rib after a splitting point is shorter than ten times the rib distance. A high regularity of the pattern means that the individual rib distance of two parallel ribs when taking into account at least twenty rib spacings (see FIGS. 6 and 7) differ less than by a factor of 2. In the following when referred to rib distance the value corresponds to an average taken over an interval perpendicular to the rib direction. The averaging is done over at least twenty individual rib distances (FIG. 7).

The roll coating apparatus suitable for applying the coatings of the present invention, preferably has three rolls. It is, however, also possible to reduce the number of rolls to one or two, e.g. by using one roll as pick-up and applicator roll and a second roll as back-up roll for transporting the substrate. If another trans-port means for the substrate, e.g. a band, is used instead of a roll, and provided that the gap formation and the fast reduction of shear forces are not affected, the back-up roll for transporting the substrate can be omitted. However, apparatus with at least two rolls are preferred.

It is also possible to use more than three rolls, e.g. a further roll between the pick-up and the applicator roll for better dosing the coating fluid. In general, however, a three roll apparatus will be sufficient and therefore the invention is further described with regard to such an apparatus.

The coating fluid must be available in amounts sufficient to fill the distance or gap between the applicator roll applying the coating and the back-up roll transporting the substrate or rather the distance or gap between the applicator roll and the substrate surface to be coated. Thus, this gap corresponds to the grammage, i.e. the higher the grammage the larger the gap. Besides of the distance between the back-up roll or substrate surface and the applicator roll also the relative speed of the rolls is important. Since for these specific coating fluids the viscosity is highly dependent on the shear rate, the viscosity abruptly rises as soon as the coated substrate leaves the gap such conserving the fine structure.

Ranges for the above addressed parameters are determined by adjusting the gap thickness (i.e. the grammage at constant mean velocity) and to a minor extend by altering the applicator or back-up roll velocity. Fine structures (i.e. rib distance<0.5 mm) can bh achieved for grammages smaller than 6 gm⁻² while the relative velocity of the back-up and the applicator roll is kept in a range of 0 to 200 m min⁻¹, more preferably 0 to 100 m min⁻¹, most preferably 0 to 50 m min⁻¹. For grammages greater than 6 gm⁻² while the relative velocity of the back-up and the applicator roll is kept in a range of 0 to 200 m min⁻¹, more preferably 0 to 100 m min⁻¹, most preferably 0 to 50 m min⁻¹ coarse structures (i.e. rib distance≧0.5 mm) are obtained.

A usual range of dimensions of the structure is e.g. from 0.1 mm to 2 mm, in particular from 0.1 mm to 1.6 mm. In this range very favorable properties were found e.g. for silicone coatings. Due to having less adhesion-exposed surface area, the ribbed films exhibit lower release properties compared to a smooth reference surface of the same polymer composition. The effects observed are dependent on the material forming the structured surface and the material getting into contact with said surface. In the case of a structured silicone surface the effects were more significant for a rubber based adhesive (Tesa® 7476) than for an acrylic based one (Tesa® 7475). This difference in effects can be attributed to the inherent high adhesion of rubber tape to the PDMS.

In the experiments hitherto performed, peel tests showed a reduced error based on the standard deviation for ribbed surfaces. The inventive method thus is suitable for the production of very low adhesion surfaces and for controlled release products, e.g. rubber based adhesive products, especially silicone release surfaces comprising rubber based adhesive products.

If desired, the structured film can be adapted to provide further features, e.g. by adding respective properties exhibiting rheology modifiers. Such features are e.g.:
UV-stability (e.g. by using TiO₂/SiO₂ nanoarticles as rheology modifier)
antimicrobial properties (e.g. by using silver doped silica rheology modifiers),
or combined properties by using combined rheology modifiers.

In order to add to the desired rheology modification, also such further properties providing rheology modifiers must be agglomerated nanoparticulate materials, suitably materials with a specific surface area>50 m²/g, most preferred >200 m²/g, and in general also with a mass fractal dimension of Dₘₐₛₛ<2.5, preferably <2.3, more preferably between 1.8 and 2.3.

The films with structured surfaces obtainable with the above described method have reduced adhesion and allow the production of controlled release products by adapting the structured surface to the desired release characteristics. The structured surfaces also lead to a reduced friction coefficient of surfaces passed by fluids and a self-cleaning effect. For example structured silicone coatings have very low adhesion to rubber based adhesives and are well suitable for controlled release products.

It has also been found that for release surfaces in contact with adhesives larger structures are preferred, e.g. structures in the range from 1 mm to 2 mm, while for the reduction of the friction resistance of fluid passed surfaces and in particular also surfaces with self-cleaning effect fine structures in the range of 0.1 mm to 1 mm are preferred.

In a further embodiment of the present invention it is also possible to subsequently modify the structured surface by application of a thin layer onto the structure, e.g. by spraying or fogging. Such additional layers may assist in fixation, stabilization, adaptation of the release characteristics etc. A non limiting example for such a modified surface is a structured top coat e.g. from UV-cured resin, subsequently topped with siloxanes.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1a is a schematic representation of a three roll coating device with co-rotating rolls, as used in the following Example for the application of fluid films on flexible substrates.

FIG. 1b is a schematic of an air-to-fluid displacement in diverging walls

FIG. 2 is a diagram showing shear stress versus shear rate of different silicone resins on a double logarithmic scale. The reference resin without silica and without solvent exhibits a Newtonian behavior while the addition of silica to the resin results in a Herschel-Bulkley fluid. The data fitting by the Herschel-Bulkley model is shown as a full line.

FIG. 3 is a diagram showing shear stress versus shear rate of different modified acrylic resins on a double logarithmic scale. The reference acrylic resin (RefUV) without silica exhibits a Newtonian behavior. Addition of silica to the resin results in a Herschel-Bulkley fluid for low silica contents (UV3) while at higher loadings (5 wt % silica, UV5) the behavior is closer to a Bingham-fluid. The data fitting by the Herschel-Bulkley model is shown as a full line.

FIG. 4 is a diagram showing viscosity as a function of shear rate and revealing the similar rheological behavior of a modified PDMS (filled symbols) and UV-curable acrylic resin (open symbols).

FIG. 5 represents light microscopy images of structured films for different solvent contents and grammages at a constant relative roll velocity of approximately 0.3 m s⁻¹. The top images show films with 5 wt % solvent content and 2 g m⁻² (left), 3.3 g m⁻² (middle), and 5.5 g m⁻² (right) grammage. The bottom images (left), 15 wt % and 3.3 g m² (middle), and 15 wt % and 4.3 g m⁻². Thin black lines are caused by the pattern of a Neubauer cell used for scaling.

FIG. 6 is a schematic representation of the two distinctly different rib patterns. Rib distances are taken as an average wavelength between each rib for both branched ribs (A) and single-tooth straight ribs (B).

FIG. 7 is a schematic of the observed rib structure with an example interval taken for representative evaluation of the rib distance.

FIG. 8 is a diagram showing the rib distance versus the grammage of the films produced with the modified silicone resin.

FIG. 9 is a diagram showing the rib distance versus the relative roll velocity at a constant gap width.

FIG. 10 is a diagram showing the release forces of two commercially pressure sensitive adhesives (Tesa® 7475, Tesa® 7476) for different coating properties.

### MODES FOR CARRYING OUT THE INVENTION

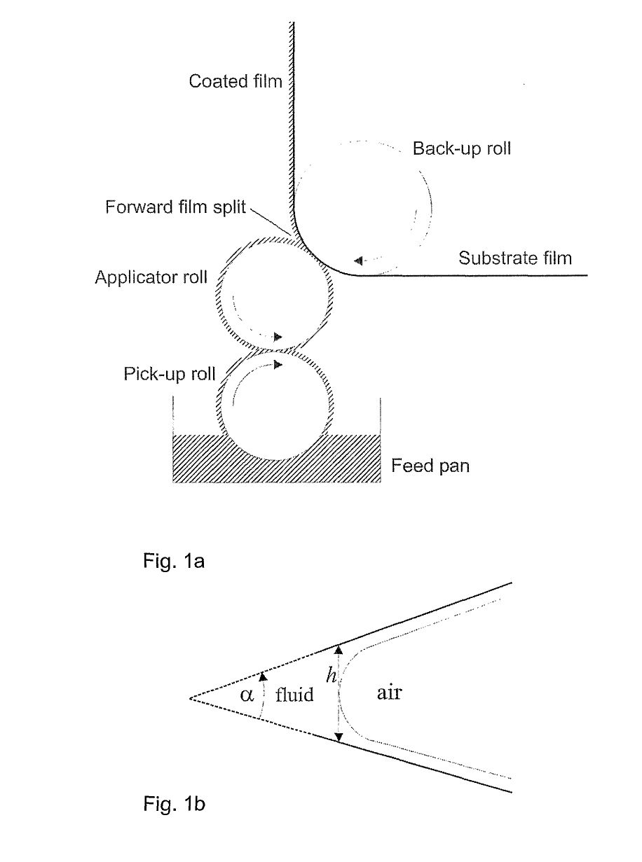

In a specific embodiment of the present invention, a structured polymeric silicone film was successfully applied on a flexible substrate by three roll direct coating in co-rotating mode (see FIG. 1a) which offers continuous, low cost production. The resin was adapted to have the rheological behaviour of a Herschel-Bulkley fluid and the coating conditions were chosen above the critical capillary number such that instability of the film split occurred (see FIG. 1b). Surfaces with branched and single-tooth ribbing of high regularity were achieved with dimensions of the structure ranging from 0.1 mm to 1.6 mm. Due to having less adhesion-exposed surface area, the ribbed silicone films exhibited lower release properties compared to a smooth reference. Effects were more significant for a rubber based adhesive (Tesa® 7476) then for an acrylic based one (Tesa® 7475) attributed to inherent high adhesion of rubber tape to the PDMS. Moreover peel tests showed a reduced error based on the standard deviation for ribbed surfaces. The proposed method thus is suitable for the production of very low adhesion surfaces and for controlled release products, especially for products comprising rubber based adhesives.

The processing of structured surfaces as described—above for silicones is not restricted to silicone resins. The same method is applicable for all fluids having the needed rheological properties as defined above.

### EXAMPLES

### 1. Film Preparation

A solventless silicone coating system, based on poly(dimethylsiloxane) (PDMS), was used as a basic raw material with the following weight proportions: 4700 parts Dehesive® 610 (Wacker Silicones), 270 parts Crosslinking Agent V24 (Wacker Silicones), 140 parts Catalyst OL (Wacker Silicones), and 10 parts 2-methyl-3-butyn-2-ol (Fluka) as an inhibitor. In the preparation method of the resin, 5 wt % silica (Aerosil® 200, Degussa) was first added to the silicon base and mixed with a conventional agitator till proper dispersion was reached. Different amounts (5 wt %, 10 wt %, 15 wt %, 20 wt % of the total resin mass) of 2-propanol (Fluka) were then mixed with the modified silicone resin. Finally the inhibitor, the crosslinker, and the catalyst were admixed and the resulting resin was applied on a high density polyethylene film (150 μm film thickness) by the aid of a laboratory scale three roll direct coating machine (FIG. 1a) with co-rotating rolls (forward roll action). The line speed was kept constant at approximately 3 m min⁻¹ while the applicator roll speed and the gap distance between the applicator roll and the substrate film was altered to achieve different coating properties. Curing of the applied topcoat was done by in-line thermal treatment until complete polymerization was reached, confirmed by simple rub-off testing. The samples in the following sections are denoted as xsol, where x stands for the weight percentage of solvent added to the modified resin. The experimental results obtained were always compared with the unmodified resin (i.e. no addition of Aerosil® 200 and solvent).

A second polymeric resin was also tested on its change of rheological behavior after addition of rheology modifier. Different amounts (3 wt %, 4 wt %, and 5 wt %) of silica (Aerosil® 200, Degussa) were admixed to an UV-curable acrylic resin (ISS-2359-1, DuPont Industrial Coatings) to obtain desired fluid properties. The samples are named UVy, where y denotes the silica content in weight percent of the total mass and the unmodified reference resin is labeled RefUV.

### 2. Characterization Methods

The dynamic viscosity of the modified resins were investigated on a controlled strain rate rheometer (ARES rheometer, Rheometric Scientific) with cone/plate (diameter 50 mm) geometry at a constant temperature of 25° C. Steady rate sweep tests of the fluids were performed over a shear rate range of 0.05 to 100 rad sec⁻¹. The grammage of the roll coated silicone films was altered from 2 g m⁻² to approximately 8 g m⁻² and measured by x-ray absorption spectroscoopy on a ASOMA 200T (ASOMA Instruments Inc.). The contribution to absorption caused by the silicon of incorporated silica was considered negligible as its relative amount to the silicon of the PDMS is small. Images of the as-prepared films were taken on a light microscope (IX51, Olympus) equipped with a digital camera system (DP12, Olympus). Peel force testing was conducted on a tensile tester (Type BZ 2.5/TN1S, Zwick) according to the FINAT test method no. 10 (FTM 10) (FINAT Technical Handbook 6^{th} edition, 2001) at a constant peel rate of 0.3 m sec⁻¹. Aging of the coatings was done for at least two weeks before testing the adhesion to industrially relevant, aggressive PSAs, Tesa® 7475 (acrylic based) and Tesa® 7476 (based on Butadiene-styrene rubber).

### 3. Results and Discussion

3.1 Resin Characteristics

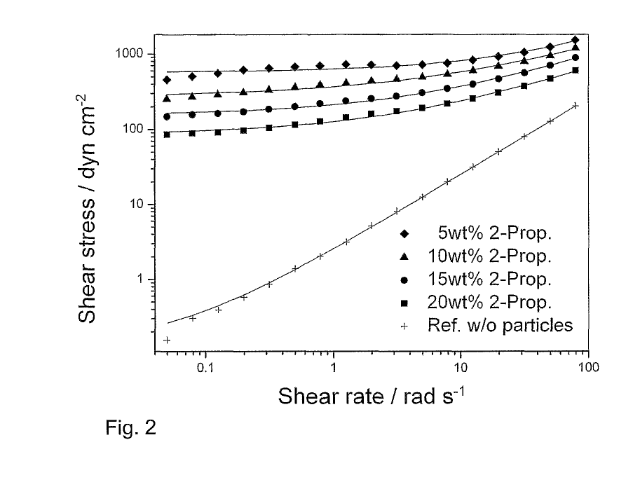

The application of modified silicone resin by conventional roll coating resulted in a structured surface pattern with well-defined dimensions. The distinct behavior of the silicone was achieved by admixing highly agglomerated silica, Aerosil® 200, which is commercially used as a rheology modifier in polymers and other fluids. Different amounts of solvent were used to thoroughly tune the final rheological behavior of the silicone polymer system. In FIG. 2 the shear stress of the as-prepared silicone resins is plotted against the shear rate on a double logarithmic scale. The shear stress as a function of shear rate can be generally expressed by the Herschel-Bulkley model already addressed above:

τ=τ₀+K·\dot{γ}ⁿ 0≦τ₀

Where τ is the shear stress, τ₀ is the yield stress, K is the power law coefficient, \dot{γ} is the shear rate, and n is the power law exponent. n=1 corresponds to Newtonian behavior and n<1 is observed in shear-thinning fluids. The parameters (τ₀, K, and n), presented in Table 1, were obtained by nonlinear least-squares data fitting of the Herschel-Bulkley model to the experimental data. It is worth mentioning that the silicone reference resin (w/o rheology modifier and w/o solvent) exhibited a flow behavior close to Newtonian (τ₀=0, n=1). For all modified silicone samples a Herschel-Bulkley behavior with an increasing yield stress for decreasing solvent content was observed. The power law coefficient was significantly higher for all silica-containing silicone resins and the shear-thinning effect was confirmed by the values of the power law exponent less than unity.

TABLE 1
Parameters of the Herschel-Bulkley
model received by fitting of experimental data.

| | Herschel-Bulkley model | | |
|---|---|---|---|
| | Yield | Power law | |
| | stress, | coefficient, | Power law |
| Sample | dyn cm⁻² | dyn cm⁻² sⁿ | exponent, — |
| Ref | 0.15 | 2.4 | 1.01 |
| 5 sol | 579 | 52 | 0.65 |
| 10 sol | 275 | 92 | 0.52 |
| 15 sol | 155 | 57 | 0.58 |
| 20 sol | 86 | 40 | 0.58 |
| RefUV | 0.71 | 2.6 | 1.00 |
| UV3 | 102 | 14 | 0.82 |
| UV4 | 344 | 12 | 0.93 |
| UV5 | 1000 | 9.2 | 1.02 |

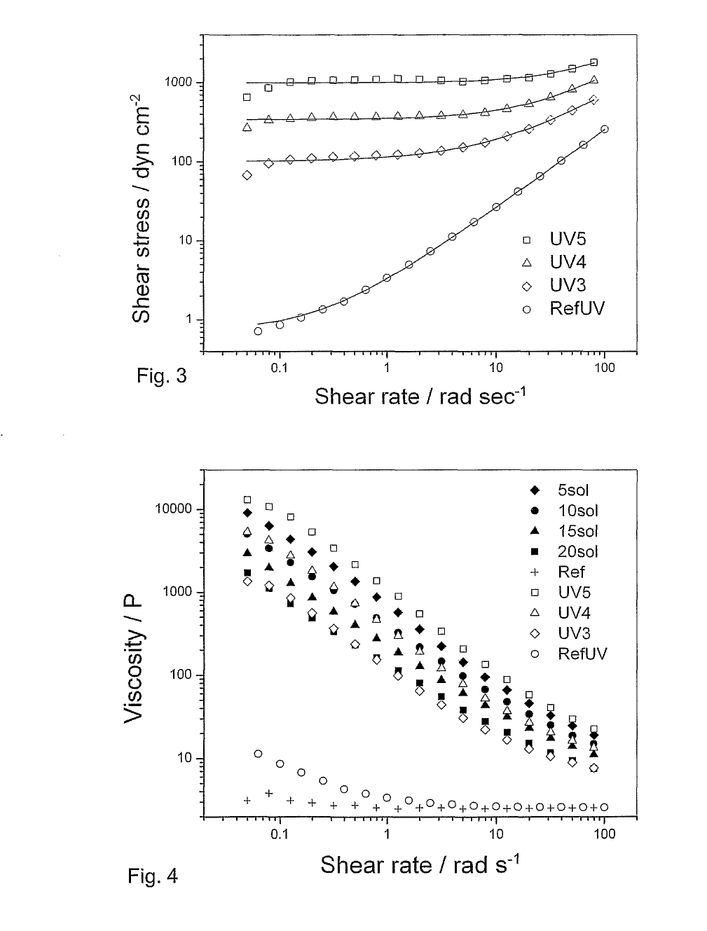

Based on the experiments done with different polymer systems it could be concluded that the rheological behavior of the applied fluid is crucial for the preparation of structured surfaces by roll coating. Extension to further polymer systems was verified by using an UV-curable acrylic resin. Application of radiation-cured systems has the major advantage of solvent free production while allowing fast line speeds. Rheological behavior of the reference and modified UV-acrylic resins are given in FIG. 3 with corresponding fitting to the Herschel-Bulkley model. In general the addition of silica could be shown to have the same effect for both polymer systems (PDMS and acrylic resin). The values of yield stress for UV-curable acrylic resins (Table 1), ranging from approximately 0.7 dyn cm⁻² to 1000 dyn cm⁻², were in the same range as the values of modified PDMS (approx. 0.2-580 dyn cm⁻²). While low silica containing resins (sample UV3, i.e. 3 wt % silica) exhibited a slight shear-thinning property (Herschel-Bulkley fluid), the high loading resin (sample UV5, i.e. 5 wt % silica) changed to Bingham behavior (n=1.02). The viscosity obtained from the measured shear stress was plotted against the shear rate for both polymeric resins (FIG. 4), revealing the high zero-stress viscosity for silica treated samples. With changing the solvent content the rheological properties of the PDMS resin could be thoroughly tuned to the desired flow-behavior. In the case of UV-curable acrylic resin the tuning was only done by adding different silica contents to avoid any addition of solvent. In the following section the benefit of a Herschel-Bulkley behavior of the applied resin was elucidated in regard to the production of a structured polymer surface.

3.2 Film Characteristics

The as prepared silicone resins were applied on HDPE-substrate films by direct three roll coating and subsequent thermal curing. Changing the production parameters such as relative applicator roll speed and coating gap distance allowed taking influence on the resulting topcoat physical properties. In the following the relative applicator roll speed referred to the speed of the applicator roll relative to the substrate film. Tuning the coating gap distance directly entailed a change in the coating thickness or grammage (i.e. applied silicone resin per square meter [g m⁻²]).

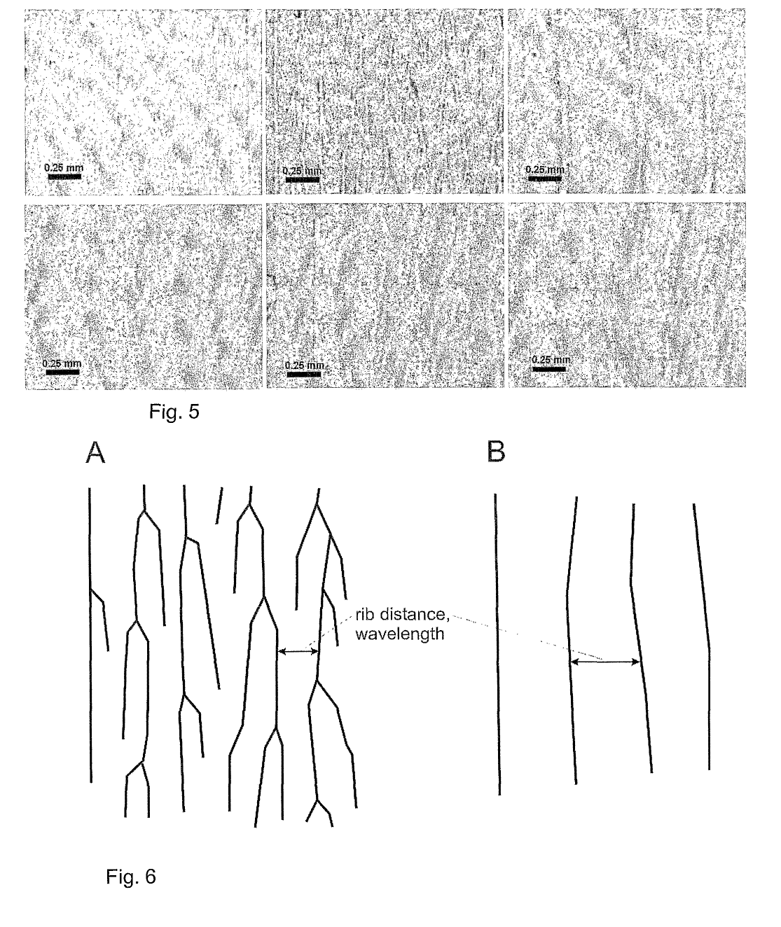

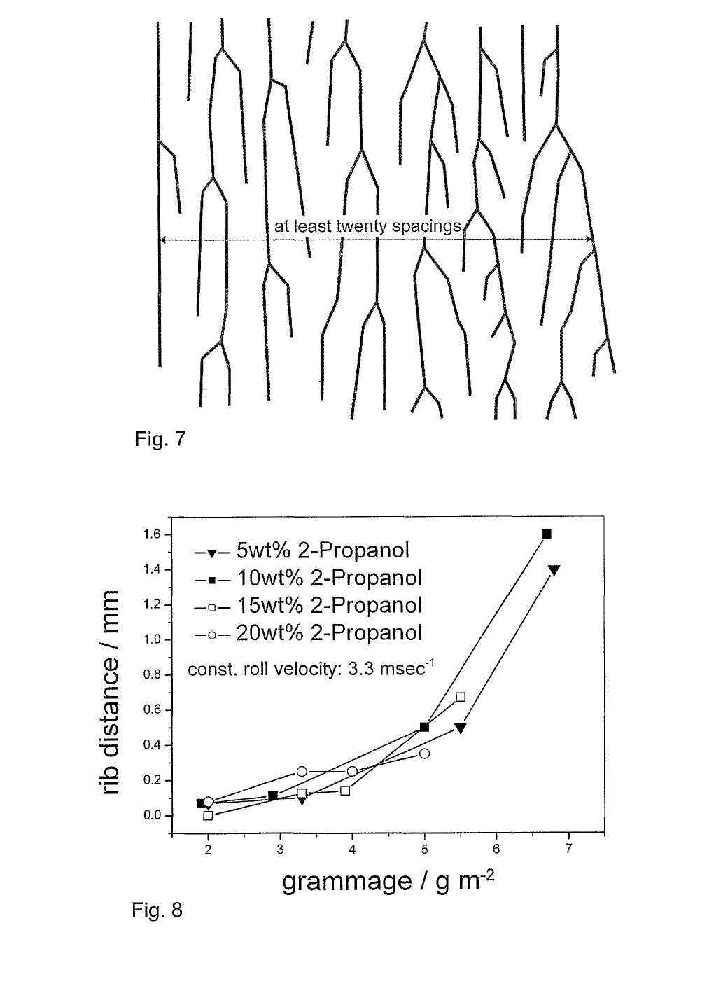

While the application of unmodified silicon resin resulted in a smooth surface the film produced from silica-treated material exhibited a clearly visible surface structure (FIG. 5) indicating that for all used conditions the critical capillary number had been exceeded. The ribbing of the film therefore could be attributed to the instability at the film split. As the high yield stress (Herschel-Bulkley or Bingham flow behaviour) of the modified resins resulted in high relaxation times the structures formed at the film split were preserved throughout the fixation step by thermal curing. All structuring showed an alignment in machine direction as could be expected from the instability consideration in the film split. The most distinct ribbing (height of ribs) was observed for low solvent content i.e. for high yield stress of the fluid (FIG. 5 top). This behavior could rise from the fact that the higher the yield stress the higher the relaxation time and the lower the deliquescing effect. The pattern of the structured surface ranged from coincidentally branched ribs (FIG. 5 top left and middle; schematic see FIG. 5A) for small gap distances (coating grammage approximately 3 g m⁻²) to highly regular ribs (FIG. 5 top right, schematic see FIG. 6B) for larger gaps (grammage≈6 g m⁻²). Saw tooth cusped patterns have been observed previously in forward applicator roll flow for elastic fluids at high capillary numbers [17], however, said structures were much larger and not conserved in the coating, therefore leading to an undefined surface. A specific wavelength of each structure was measured perpendicular to the machine direction and plotted against the gap distance for a constant relative roll velocity of approximately 0.3 m min⁻¹ (FIG. 8). Increasing the grammage of the coating (i.e. increasing gap distance) drastically increased the wavelength while a change in solvent content had little effect on the rib distance. The dimensions accessible with the used conditions ranged from approximately 0.1 mm to 1.6 mm.

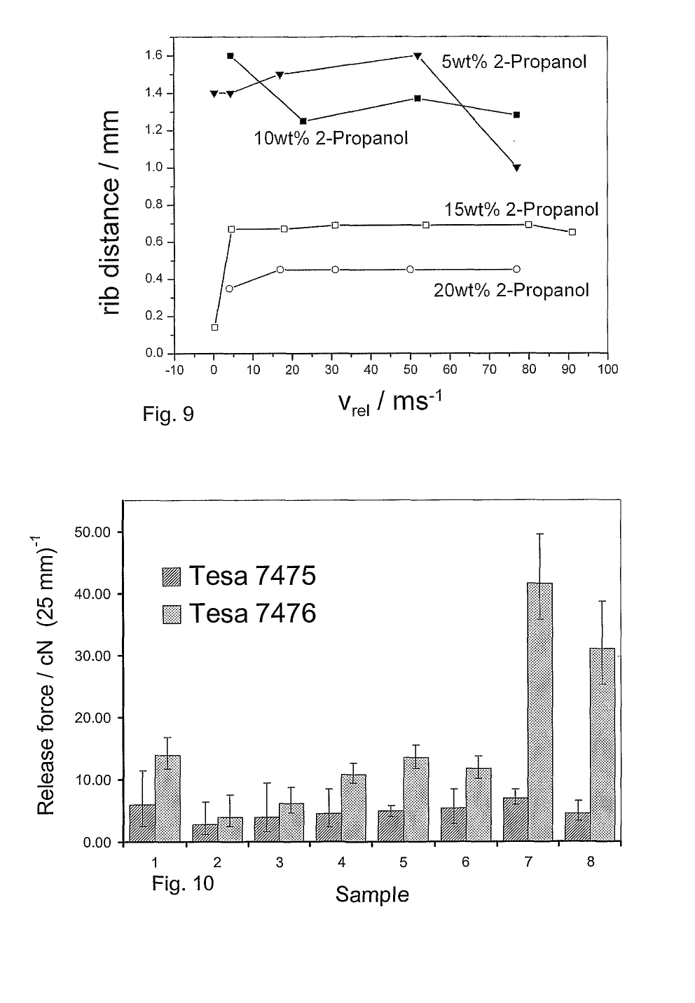

The influence of relative roll velocity on rib distance at constant gap width has also been investigated for different solvent containing resins (FIG. 9). While the change in velocity had very little effect on the wavelength of the ribs for high solvent contents (15 wt % and 20 wt %) a slightly decreasing trend for low solvent containing resins (10 wt % and 5 wt %) was observed. However, increasing the solvent content resulted in a drastic decrease of wavelength for a fixed gap width. Under these conditions a rib distance of approximately 1.4 mm for 5 wt % solvent changed to 0.5 mm for 20 wt % solvent content. Furthermore the ribs showed more distinct patterning (rib height) for lower velocities while at very high relative speeds (>60 m s⁻¹) the ribs flatted out which was attributed to the shear-thinning properties of the resin.

3.3 Adhesion Properties

A selected set of films exhibiting a promising ribbing were tested for the release properties of two different commercial adhesives and were compared to the unmodified smooth surface of a reference film. All films were made from the same silicone polymer. This ruled out that any material properties were influencing the experiments. The processing parameters and rib properties for all tested films are listed in Table 2.

TABLE 2
Preparation conditions and film properties
of samples studied in peel tests.

| | Solvent | | Rel. | Rib |
|---|---|---|---|---|
| | content, | Grammage, | velocity, | distance, |
| Sample | wt % | g m⁻² | m s⁻¹ | mm |
| 1 | 5 | 6.8 | 4.4 | 1.4 |
| 2 | 5 | 6.6 | 52 | 1.6 |
| 3 | 10 | 6.7 | 4.4 | 1.6 |
| 4 | 10 | 6.9 | 23 | 1.3 |
| 5 | 15 | 5.7 | 4.6 | 0.7 |
| 6 | 15 | 5.5 | 18 | 0.7 |
| 7 | 0 | 2 | 4.4 | — |
| 8 | 0 | 6 | 4.4 | — |

Release forces of an acrylic based (Tesa® 7475) and a rubber based (Tesa® 7476) PSA were measured with constant peel rate (0.3 m s⁻¹) at room temperature (FIG. 10). At least ten measurements were conducted and the forces were averaged over the whole peel process. The errors were taken as the averaged minimal and maximal values obtained in the testing. First it was found that the release force for the acrylic based adhesive (Tesa® 7475) in general was rather low (around 5 cN (25 mm)⁻¹) but a minimal value of 2.7 cN (25 mm)⁻¹ was obtained for structured sample number 2. The low values even for the smooth silicone film could be attributed to the nature of the adhesive since silicone release films are generally more effective for acrylic based adhesion. The release properties therefore were found to depend predominantly on the material properties. A much lager effect on the release properties was detected for the rubber based adhesive (Tesa® 7476) which is more aggressive to silicon liners. Release force could be drastically reduced by the ribbing as observed for samples number 1 to 6. Again most effective change were shown by sample number 2 which corresponds to a long wavelength (1.4 mm) with distinct ribbing arising from the high yield stress of the low (5 wt %) solvent content. The peel force in this case compared to a smooth surface with similar coating thickness (sample 8) was reduced by a factor of around eight. A second advantageous feature is the smaller standard deviation around the mean peel force value for structured films (approx. 2 cN (25 mm)⁻¹) in comparison with the reference sample 8 (approx. 6 cN (25 mm)⁻¹), supporting the finding that a higher control of the release properties can be achieved by using ribbed surface structures.

While there are shown and described presently preferred embodiments of the invention, it is to be distinctly understood that the invention is not limited thereto but may be otherwise variously embodied and practiced within the scope of the following claims.

### REFERENCES

1. Gordon, G. V., et al., Forcing the issue. Adhesives Age, 2000. 43(4): p. 41-44.
2. Yebra, D. M., S. Kiil, and K. Dar-Johansen, Antifouling technology—past, present and future steps towards efficient and environmentally friendly antifouling coatings. Progress in Organic Coatings, 2004. 50(2): p. 75-104.
3. Owen, M. J., Surface properties of silicone release coatings. Jocca-Surface Coatings International, 1996. 79(9): p. 400-403.
4. Owen, M. J., A review of significant directions in fluorosiloxane coatings. Surface Coatings International Part B-Coatings Transactions, 2004. 87(2): p. 71-76.
5. Kobayashi, H. and M. J. Owen, Surface-Properties of Fluorosilicones. Trends in Polymer Science, 1995. 3(10): p. 330-335.
6. Gordon, G. V., et al., Silicone release coatings: An examination of the release mechanism. Adhesives Age, 1998. 41(11): p. 35-42.
7. Gordon, G. V., et al., Sticking lightly. Adhesives Age, 2002. 45(7): p. 24-31.
8. Bechert, D. W. and M. Bartenwerfer, The Viscous-Flow on Surfaces with Longitudinal Ribs. Journal of Fluid Mechanics, 1989. 206: p. 105-129.
9. Bechert, D. W., M. Bruse, and W. Hage, Experiments with three-dimensional riblets as an idealized model of shark skin. Experiments in Fluids, 2000. 28(5): p. 403-412.
10. Bechert, et al., Fluid mechanics of biological surfaces and their technological application. Naturwissenschaften, 2000. 87(4): p. 157-171.
11. Coyle, D. J., C. W. Macosko, and L. E. Scriven, Film-Splitting Flows in Forward Roll Coating. Journal of Fluid Mechanics, 1986. 171: p. 183-207.
12. Benjamin, D. F., T. J. Anderson, and L. E. Scriven, Multiple Roll Systems—Steady-State Operation. Aiche Journal, 1995. 41(5): p. 1045-1060.
13. Greener, Y. and S. Middleman, Theory of Roll Coating of Viscous and Viscoelastic Fluids. Polymer Engineering and Science, 1975. 15(1): p. 1-10.
14. Carvalho, M. S. and L. E. Scriven, Deformable roll coating flows: Steady state and linear perturbation analysis. Journal of Fluid Mechanics, 1997. 339: p. 143-172.
15. Carvalho, M. S. and L. E. Scriven, Three-dimensional stability analysis of free surface flows: Application to forward deformable roll coating. Journal of Computational Physics, 1999. 151(2): p. 534-562.
16. Decre, M., E. Gailly, and J. M. Buchlin, Meniscus control by string in roll coating experiment. Aiche Journal, 1996. 42(6): p. 1583-1589.
17. Grillet, A. M., A. G. Lee, and E. S. G. Shaqfeh, Observations of ribbing instabilities in elastic fluid flows with gravity stabilization. Journal of Fluid Mechanics, 1999. 399: p. 49-83.
18. Hasegawa, T. and K. Sorimachi, Wavelength and Depth of Ribbing in Roll Coating and Its Elimination. Aiche Journal, 1993. 39(6): p. 935-945.
19. Abbasi, F. and H. Mirzadeh, Adhesion between modified and unmodified poly(dimethylsiloxane) layers for a biomedical application. International Journal of Adhesion Adhesives, 2004. 24: p. 247-257.
20. Barthlott W. and C. Neinhuis, Purity of the sacred lotus, or escape from contamination in biological surfaces. Planta, 1997. 202: p. 1-8.
21. Eldada, L. and L. W. Shacklette, Advances in polymer integrated optics. IEEE Journal of Selected Topics in Quantum Electronics, 2000. 6(1): p. 54-68.
22. Pearson, J. R. A., The Instability of Uniform Viscous Flow under Rollers and Spreaders. Journal of Fluid Mechanics, 1960. 7(4): p. 481 ff.
23. Pitts, E. and J. Greiller, The Flow of Thin Liquid Films between Rollers. Journal of Fluid Mechanics, 1961. 11(1): p. 33-50.
24. Mill, C. C. and G. R. South, Formation of Ribs on Rotating Rollers. Journal of Fluid Mechanics, 1967. 28: p. 523 ff.
25. Greener, J., et al., Ribbing Instability of a 2-Roll Coater—Newtonian Fluids. Chemical Engineering Communications, 1980. 5(1-4): p. 73-83.
26. Rabaud, M., S. Michalland, and Y. Couder, Dynamical Regimes of Directional Viscous Fingering—Spatiotemporal Chaos and Wave-Propagation. Physical Review Letters, 1990. 64(2): p. 184-187.
27. Coyle, D. J., C. W. Macosko, and L. E. Scriven, Stability of Symmetrical Film-Splitting between Counter-Rotating Cylinders. Journal of Fluid Mechanics, 1990. 216: p. 437-458.
28. Saffman, P. G. and G. Taylor, The Penetration of a Fluid into a Porous Medium or Hele-Shaw Cell Containing a More Viscous Liquid. Proceedings of the Royal Society of London Series a-Mathematical and Physical Sciences, 1958. 245(1242): p. 312 ff.
29. McCloud, K. V. and J. V. Maher, Experimental Perturbations to Saffman-Taylor Flow. Physics ReportsReview Section of Physics Letters, 1995. 260(3): p. 139-185.
30. Lindner, A., P. Coussot, and D. Bonn, Viscous fingering in a yield stress fluid. Physical Review Letters, 2000. 85(2): p. 314-317.

1. A roll coating method for preparing a coated substrate with structured surface of the coating comprising application of a polymer based coating fluid to a substrate surface by means of a coating fluid application roll and then curing the applied coating, wherein the polymer based coating fluid is a fluid showing Bingham or Herschel-Bulkley flow behavior with a yield stress τ₀>10 dyn cm⁻².

2. The method of claim 1, wherein the capillary number of the gap between the coating fluid application roll and the substrate surface to be coated is above the critical capillary number if calculated according to the formula
$${Ca}_{crit} = \frac{1}{3} tan ( \frac{α}{2} ) + \frac{( ρ - {ρ}_{air} ) {gh}^{2} cos ( β )}{12 σ}$$
where α is the divergence angle, ρ is the density of the applied fluid, ρₐᵢᵣ is the air density, g is the gravity constant, σ is the surface tension of the applied fluid, h is the local gap thickness at the meniscus, and β is the angular location of the meniscus (while β=0 in horizontal position).

3. The method of claim 1 wherein the fluid is a Herschel-Bulkley fluid with low viscosity at high shear rate, fast viscosity enhancement in the absence of shear stress and a high yield stress.

4. The method of claim 1 wherein the viscosity behavior of the coating fluid comprises a high yield stress of >50 dyn cm⁻².

5. The method of claim wherein the viscosity behavior of the coating fluid comprises a relatively low viscosity of <10 Pa s at high shear rates of >50 rad sec⁻¹.

6. The method of claim 1 wherein the structured surface has a predominantly branched or predominantly single-tooth ribbing of high regularity.

7. The method of claim 4 wherein the dimensions of the structure rage from 0.1 mm to 2 mm, in particular 0.1 mm to 1.6 mm.

8. The method of claim 1, wherein the structured surface is modified by application of a thin layer.

9. A polymer based coating fluid, said coating fluid comprising rheology modifiers that are highly agglomerated particles.

10. The polymer based coating fluid of claim 9, wherein said coating fluid comprises a solvent.

11. The polymer based coating fluid of claim 9, said coating fluid comprising a high yield stress of >50 dyn cm⁻².

12. The polymer based coating fluid of claim 9, said coating fluid comprising a relatively low viscosity of <100 Poise, <10 Pa s, at high shear rates of >50 rad sec⁻¹.

13. The polymer based coating fluid of claim 9, wherein said rheology modifier is an agglomerated, nanoparticulate material, in particular an inorganic material, especially materials with a specific surface area >50 m²/g, more preferred >200 m²/g.

14. The polymer based coating fluid of claim 9, wherein the agglomerated particulate material has a mass fractal dimension of Dₘₐₛₛ<2.5, preferably <2.3, more preferably between 1.8 and 2.3.

15. The polymer based coating fluid of claim 9, wherein said rheology modifier has UV-stabilizing properties and/or antimicrobial properties.

16. The polymer based coating fluid of claim 9, wherein said rheology modifier is selected from the group consisting of SiO₂, TiO₂/SiO₂, silver doped silica, and combinations of two or more thereof.

17. A substrate comprising a structured surface, in particular a substrate obtainable by a roll coating method of claim 1, said structured surface having a predominantly branched or predominantly single-tooth ribbing of high regularity.

18. The substrate of claim 17, wherein said structured surface has dimensions of the structure in the range from 0.1 mm to 2 mm, in particular from 0.1 mm to 1.6 mm.

19. The substrate of claim 18, wherein said structured surface has dimensions of the structure in the range from 1 mm to 2 mm, in particular from 1 mm to 1.6 mm.

20. The substrate of claim 18, wherein said structured surface has dimensions of the structure in the range from 0.1 mm to 1 mm.

21. An adhesive comprising product comprising an adhesive applied onto a substrate according to claim 17.

22. The adhesive comprising product of claim 21 wherein the structured surface is a silicone surface, in particular a poly dimethyl siloxane surface, and the adhesive is a rubber based adhesive.

23. Method of using a structured surface of claim 17, as self cleaning surface in outdoor application or as easy-to-clean surface for application in food production, hospitals, public transport, and public and/or office space.

24. Method of using a using a structured surface of claim 17 in friction reducing applications involving aerodynamic and hydrodynamic optimization of vehicles such as airplanes, cars and ships.

25. Method of using a structured surface of claim 20 as self cleaning surface in outdoor application or as easy-to-clean surface for application in food production, hospitals, public transport, and public and/or office space.

26. Method of using a structured surface of claim 20 in friction reducing applications involving aerodynamic and hydrodynamic optimization of vehicles such as airplanes, cars and ships.
